(19) United States
(12) Patent Application Publication
(10) Pub. No.: US 2010/0258461 A1
(43) Pub. Date: Oct. 14, 2010

(54) CASES FOR STORING AN OPTICAL DISC

(76) Inventors: Caroline Mary Challoner, Vale of Glamorgan (GB); Owain Rhys Thomas, Vale of Glamorgan (GB)

Correspondence Address: KING & SCHICKLI, PLLC, 247 NORTH BROADWAY, LEXINGTON, KY, 40507, US

(21) Appl. No.: 12/681,192

(22) PCT Filed: Oct. 1, 2008
(86) PCT No.: PCT/GB08/03291

§ 371 Date: May 25, 2010

Related U.S. Application Data
(60) Provisional application No. 60/977,104, filed on Oct. 3, 2007.

(30) Foreign Application Priority Data
Oct. 4, 2007 (GB) 0719381.6

(51) Int. Cl. B65D 85/57; B31B 49/02

(52) U.S. Cl. 206/308.1; 493/84

(57) ABSTRACT

According to the invention there is provided a case (36) for storing an optical disc (38) which defines an inner region in which the optical disc is stored and includes retaining means (32, 34) disposed in the inner region for releasably retaining the optical disc in a predetermined position, wherein the case consists essentially of paper and/or cardboard and includes a paper or cardboard honeycomb portion (10).

This invention relates to cases for storing an optical disc, such as a compact disc (CD) or a digital versatile disc (DVD), and to methods for manufacturing same.

Optical discs such as CDs and DVDs are ubiquitous items which are used for storing a wide variety of important and popular items, information and data, including music, games, movies and software. Traditionally, optical discs have been stored and packaged in a so-called “soft box” arrangement which is fabricated from plastic (the term “jewel box is also used, typically to describe cases for storing music CDs). Soft boxes of this type are not environmentally friendly, having a large carbon footprint associated with the very large production volumes, the use of plastic, and the long distances over which the soft boxes are typically transported from their point of production to a point of assembly in which the optical disc is inserted into the jewel box. Additionally, soft boxes are quite brittle. From an environmental perspective, there would be much interest in utilising a storage device for an optical disc which is fabricated at least substantially from a more environmentally friendly and preferably renewable source. Various proposals have been put forward to fabricate such devices from paper or cardboard, but to date none of these proposals have been able to provide a storage device which is of practical utility, e.g. one which is strong and robust enough for practical usage and is visually appealing to the consumer.

The present invention, in at least some of its embodiments, addresses the above described problems and desires.

According to a first aspect of the invention there is provided a case for storing an optical disc which defines an inner region in which the optical disc is stored and includes retaining means disposed in the inner region for releasably retaining the optical disc in a predetermined position, wherein the case consists essentially of paper and/or cardboard and includes a paper or cardboard honeycomb portion.

By “consists essentially” it is meant that the major components of the case, principally the main structural components such as a main body and any cover portion, inserts or the like, are formed from paper and/or cardboard. The case may include other, minor components such as adhesives, inks or any other substance used to provide indicia.

By “honeycomb” it is meant a structure having an array of interconnected cells, the array generally extending along at least two orthogonal axes. The cells define channels and preferably the channels are disposed in the case so that said channels are substantially perpendicular to the flat surfaces of an optical disc stored in the case. In preferred embodiments, the honeycomb is formed from an arrangement of paper or cardboard strips which are joined at a series of nodes by suitable means, such as adhesive, to form a honeycomb structure having a plurality of cells.

The present inventors have realised that honeycomb of the type utilised in the present invention can have an extremely high strength to weight ratio, and thus can provide excellent support and protection for the optical disc. This in turn has made it possible to provide a paper and/or cardboard case which can be biodegradable, compostable, recyclable, and manufactured from renewable and recycled resources. It is preferred that the honeycomb portion is formed from paper.

Advantageously, the case includes a bed for supporting an optical disc which is retained by the retaining means, in which the bed includes the paper or cardboard honeycomb portion. Conveniently, the bed includes a pouch into which the paper or cardboard honeycomb portion is inserted.

Preferably, the bed further includes the retaining means. Most preferably, the bed further includes a top face disposed over the paper or cardboard honeycomb portion, in which the retaining means are disposed on the top face and the top face in part defines the inner region.

The retaining means may include a slit formed in the top face for receiving a portion of the optical disc.

Additionally, or alternatively, the retaining means may include a tab formed on the top face.

The honeycomb portion may be of variable depth, and may have an area of lower depth, which area corresponds generally to the surface area of the optical disc thereby providing a recess into which the optical disc can be positioned.

Preferably, the case further includes a cover portion which can be positioned over both the bed and an optical disc retained by the retaining means. Advantageously, the cover portion is foldable enabling the cover portion to be folded over the bed. Alternative arrangements, such as a sliding arrangement in which the cover portion is slidably movable so as to position same over both the bed and an optical disc retained by the retaining means.

Advantageously, the paper or cardboard honeycomb portion is substantially in the form of a slab having an upper and a lower face.

Preferably, a paper or cardboard sheet is affixed to each of said upper and lower faces of the honeycomb portion.

Preferably, the honeycomb portion has a honeycomb structure having channels which extend between the upper and lower faces. This arrangement can provide excellent strength and rigidity.

Advantageously, the pouch, top face and cover portion are formed from a single piece of sheet material. This leads to ease of manufacture, since a number of the major components of the case can be produced from a single item of sheet material through a relatively straightforward cutting and folding operation. Furthermore, it is advantageous that a single printing operation on one side of the sheet material can result in printing which is disposed throughout the final case when assembled, i.e. with printing on front and back exterior surfaces of the case and an interior surface of the case on which the optical disc is retained. A further advantage is that the appropriately cut sheet material can be flat packaged for transportation to an assembly site where the optical disc can be positioned in the case as part of the assembly process. This is in contrast to prior art soft box cases where the case is manufactured at one site and is typically transported over long distances to a second site where the optical disc is inserted into the case.

According to a second aspect of the invention there is provided a kit of parts for manufacturing a case of the first aspect of the invention, the kit of parts including a paper or cardboard honeycomb portion.

According to a third aspect of the invention there is provided a method of manufacturing a case for storing an optical disc including the steps of: providing components of the case which components consist essentially of paper and/or cardboard and include a paper or cardboard honeycomb portion; and assembling the components to provide a case for storing an optical disc which defines an inner region in which the optical disc is stored and includes retaining means disposed in the inner region for releasably retaining the optical disc in a predetermined position.

The step of assembling the components may include the step of inserting the paper or cardboard honeycomb portion into a pouch. The pouch may be in hinged connection with a first portion which first portion is in hinged connection with second portion, and the step of assembling the components may further include the steps of folding the first portion over the pouch to provide a top face which is disposed over the paper or cardboard honeycomb portion, and folding the second portion over the top face to provide a cover portion.

Whilst the invention has been described above, it extends to any inventive combination of the features set out above or in the following description, drawings or claims.

Embodiments of cases in accordance with the invention will now be described with reference to the accompanying drawings, in which:

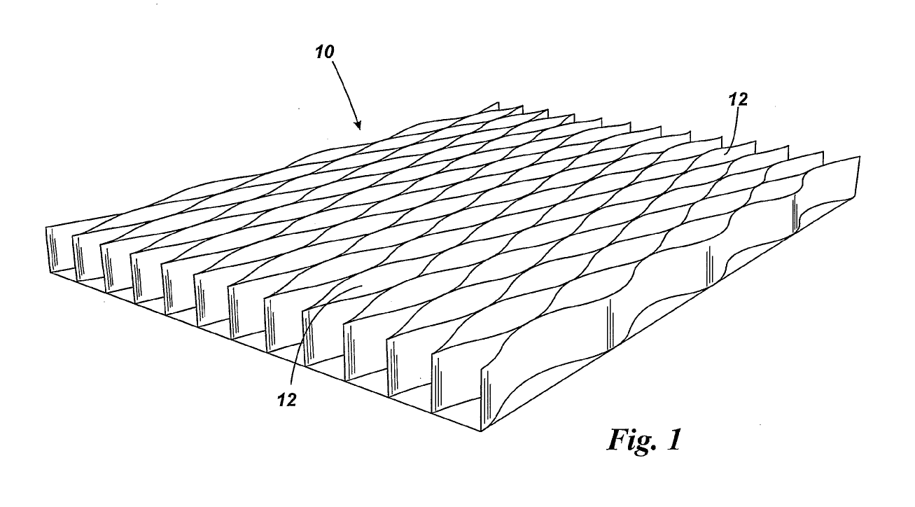

FIG. 1 is a perspective view of a honeycomb support layer;

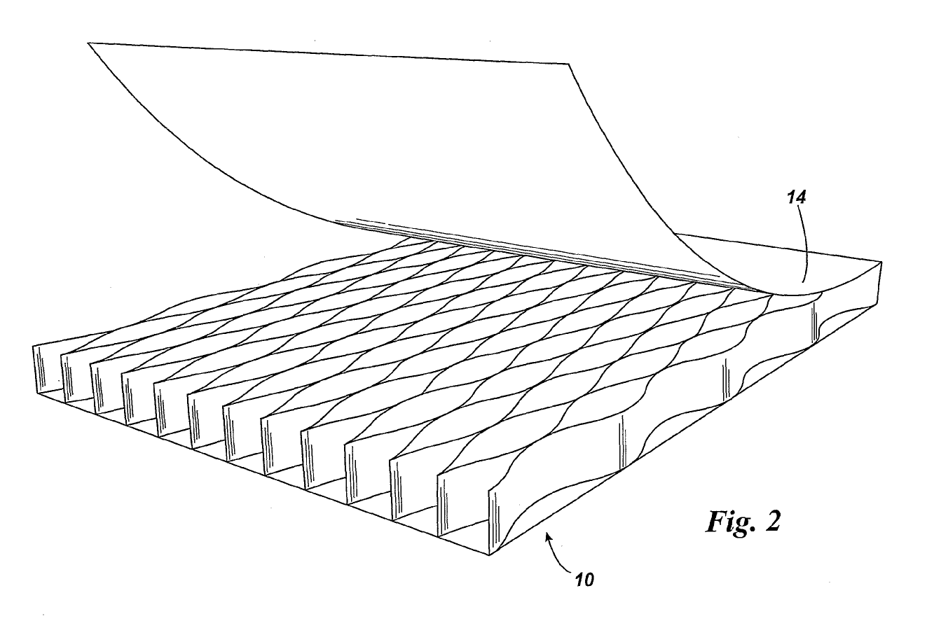

FIG. 2 is a perspective view of a honeycomb support layer with a top sheet being attached thereto;

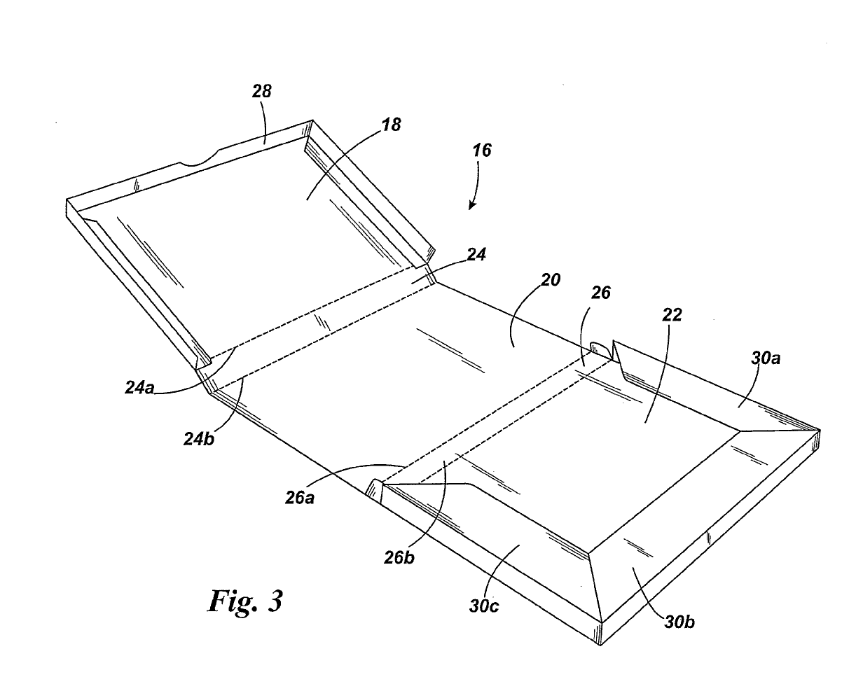

FIG. 3 is a perspective view of a framework for a case of the invention;

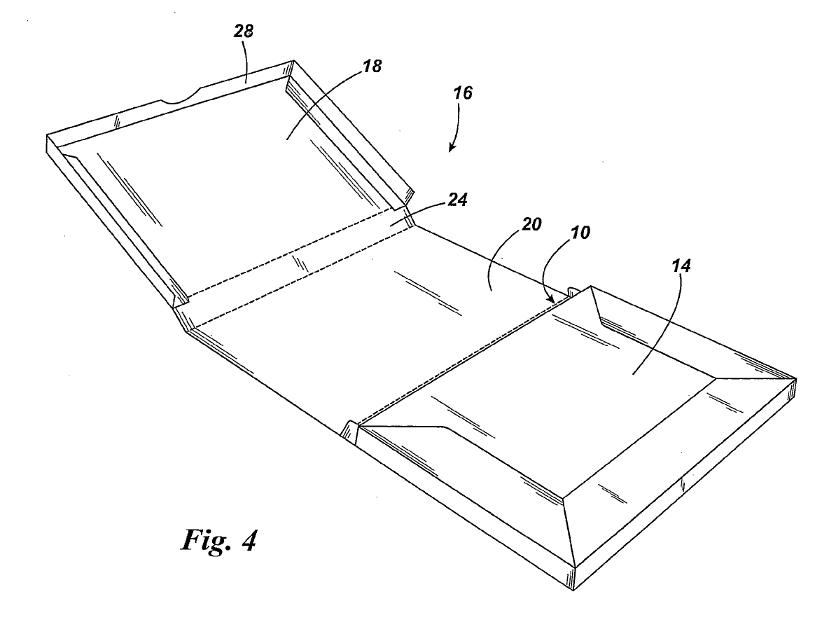

FIG. 4 is a perspective view of a framework for a case of the invention with a honeycomb support layer in place;

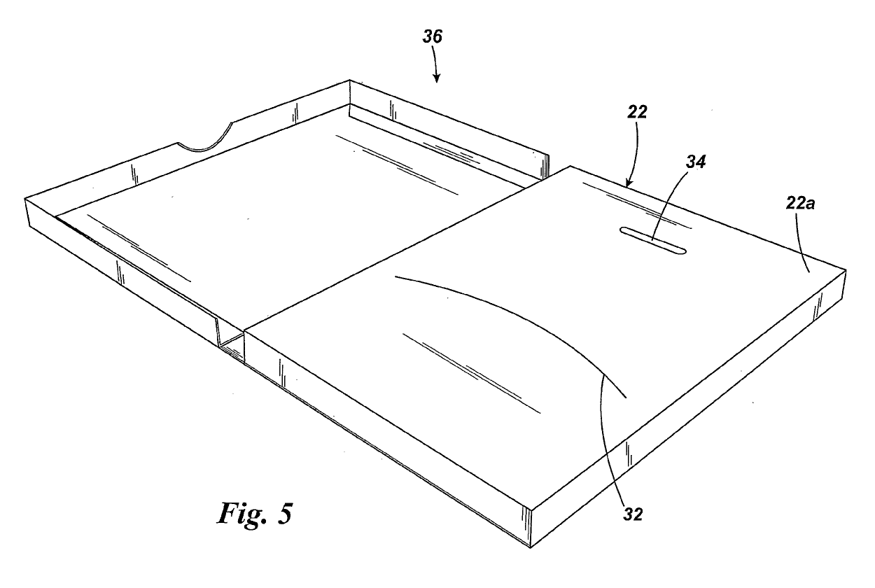

FIG. 5 is a perspective view of a case of the invention in its open, or unfolded, configuration;

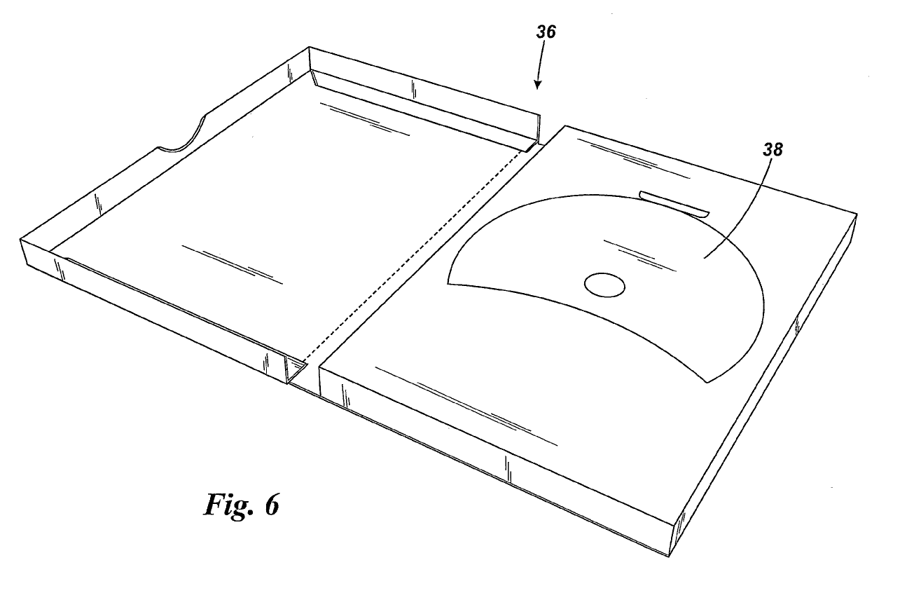

FIG. 6 is a perspective view of a case of the invention with an optical disc positioned therein; and

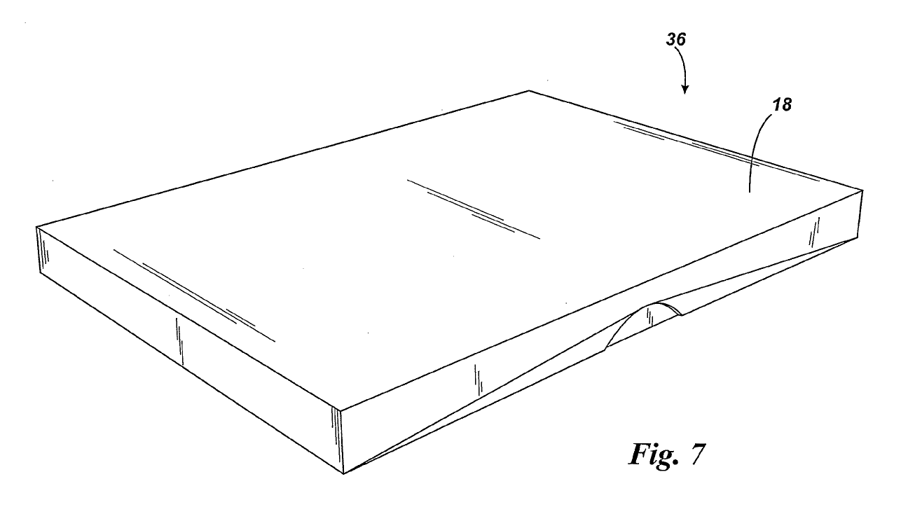

FIG. 7 is a perspective view of a case of the invention in its closed, or folded, configuration.

The drawings depict various stages in the manufacture of a case of the invention. FIG. 1 shows a honeycomb support layer, depicted generally at 10, which is made from cardboard or, preferably, paper. The honeycomb arrangement provides a plurality of cells 12. The honeycomb layer 10 is in the form of a rectangular bed the depth of which is substantially less than its width and length. The honeycomb layer 10 thus has two major faces, each of which describe a plane. The cells 12 of the honeycomb layer 10 extend transversely to the planes defined by the major faces of the honeycomb layer 10.

FIG. 2 depicts the application of a top cover sheet 14 to the honeycomb layer 10. A bottom cover sheet (not shown) is also attached to the other, lower, major face of the honeycomb layer 10. Typically the sheet 14 is formed from paper, and is glued in place using a high tack glue. It is generally necessary to use a high tack glue owing to the relatively low surface area of the honeycomb arrangement, and it is advantageous that the honeycomb portion 10 is attached to the sheets in this manner, rather than directly to the major surfaces of the case. This is because the use of high tack glue can result in a phenomenon known as “telegraphing” where the presence of glue on one side of a board can be seen from the other side, resulting in an unsightly appearance.

FIG. 3 shows a framework structure 16 which comprises a first face portion 18, a second face portion 20 and a third face portion 22. The first face portion 18 is in connection with the second face portion 20 through a spine 24 which has fold lines 24a, 24b disposed along the boundaries of the spine 24 with the first face portion 18 and second face portion 20, respectively. The second face portion 20 is in connection with the third face portion 22 through a spine 26 which has fold lines 26a, 26b at the boundaries of the spine 26 with the second face portion 20 and third face portion 22, respectively. The first face portion 18 has a three sided rim 28, and the third face portion 22 has three upstanding portions 30a, 30b, 30c which upstand from the three sides of the face portion 22 which are not in contact with the spine 26. Each upstanding portion 30a, 30b, 30c is folded inwards towards the third face portion 22 so that a pocket is formed above the third face portion 22. It will be appreciated that the framework 16 shown in FIG. 3 can be highly conveniently fabricated from a single item of sheet material using conventional techniques. Another advantage is that, as will become apparent below, a single printing operation which prints onto the lower surfaces of the face portions 18, 20, 22 (i.e. the surfaces not shown in FIG. 3) will result in a final case product which has printing on all the major exposed surfaces thereof.

The next stage in the manufacture of the case is the insertion of the honeycomb portion 10 into the pouch provided by the third face portion 22 and the upstanding portions 30a, 30b, 30c. Because the honeycomb portion 10 is covered with a top and bottom sheet, it is possible to use a relatively low-tack adhesive to affix the honeycomb portion 10 in place, and therefore the potential problem of “telegraphing” is avoided. FIG. 4 shows the framework 16 with the honeycomb portion 10 inserted in the pouch described above. The combination of the pouch formed by the third face portion 22, the upstanding portions 30a, 30b, 30c and the honeycomb portion 10 forms a rigid, strong and light bed upon which an optical disc can be housed.

Next, the third face portion 22 is folded back towards the second face portion 20, and the bed is fixed to the second face portion 20 using suitable means such as an adhesive. This results in the configuration shown in FIG. 5, where the face of the second face portion 22 which is not shown in FIG. 3 is now visible. This side of the third face portion 22 acts as a top face 22a of the bed, and has one or more features formed thereon for releasably retaining an optical disc in place. A slit 32 is provided in the top face 22a, and is a particularly convenient means for housing an optical disc. Additionally, a tab 34 may be provided. The slit 32 and tab 34 can be provided at the stage at which the framework 16 is originally produced from a sheet material. FIG. 6 shows the case 36 with an optical disc 38 inserted therein. FIG. 7 shows the case 36 in its closed, folded configuration. It, will be apparent that the first face portion 18 acts as a front cover for the case 36 and the second face portion 20 acts as a back cover.

In this way an aesthetically appealing case for optical discs can be manufactured which has excellent strength properties permitting safe transit, display and consumer use of the case. The honeycomb portion can be assembled either using an adhesive to join separate pieces of paper or cardboard, or by having slots formed in the paper or cardboard which allow pieces to be assembled in an interlocked manner. Other embodiments are possible. For example, the front cover portion of the case may be positioned using a method other than folding, for example by sliding the front cover. Also, the optical disc may be carried in a tray or other suitable arrangement which is physically separate from the supporting bed which includes the honeycomb portion. Honeycomb having variable depths might be used; in particular, a circular area of honeycomb corresponding to the surface area of the optical disc may be of smaller depth than the remainder of the honeycomb portion, thereby providing a recess into which the optical disc may be introduced. In general, the depth of the honeycomb can be varied to create thicker or thinner case depth. Other variations utilising honeycomb to produce cases for optical discs would suggest themselves to the skilled person.

1. A case for storing an optical disc which defines an inner region in which the optical disc is stored and includes retaining means disposed in the inner region for releasably retaining the optical disc in a predetermined position, wherein the case consists essentially of paper and/or cardboard and includes a paper or cardboard honeycomb portion.

2. A case according to claim 1 including a bed for supporting the optical disc retained by the retaining means, in which the bed includes the paper or cardboard honeycomb portion.

3. A case according to claim 2 in which the bed includes a pouch into which the paper or cardboard honeycomb portion is inserted.

4. A case according to claim 2 in which the bed further includes the retaining means.

5. A case according to claim 4 in which the bed further includes a top face disposed over the paper or cardboard honeycomb portion, in which the retaining means are disposed on the top face and the top face in part defines the inner region.

6. A case according to claim 5 in which the retaining means includes a slit formed in the top face for receiving a portion of the optical disc.

7. A case according to claim 5 in which the retaining means includes a tab formed on the top face.

8. A case according to claim 1 in which the honeycomb portion is of variable depth, and has an area of lower depth which area corresponds generally to the surface area of the optical disc thereby providing a recess into which the optical disc can be positioned.

9. A case according to claim 2 further including a cover portion which can be positioned over both the bed and an optical disc retained by the retaining means.

10. A case according to claim 9 in which the cover portion is foldable enabling the cover portion to be folded over the bed.

11. A case according to claim 1 in which the paper or cardboard honeycomb portion is substantially in the form of a slab having an upper and a lower face to each of which is affixed a paper or cardboard sheet.

12. A case according to claim 1 in which the paper or cardboard honeycomb portion is substantially in the form of a slab having an upper and a lower face and has a honeycomb structure having channels which extend between the upper and lower faces.

13. A case according to claim 9 in which the pouch, top face and cover portion are formed from a single piece of paper or cardboard sheet material.

14. A kit of parts for manufacturing a case according to claim 1 including a paper or cardboard honeycomb portion.

15. A method of manufacturing a case for storing an optical disc including the steps of: providing components of the case which components consist essentially of paper and/or cardboard and include a paper or cardboard honeycomb portion; and assembling the components to provide a case for storing an optical disc which defines an inner region in which the optical disc is stored and includes retaining means disposed in the inner region for releasably retaining the optical disc in a predetermined position.

16. A method according to claim 15 in which the step of assembling the components includes the step of inserting the paper or cardboard honeycomb portion into a pouch.

17. (canceled)
